(19) United States
(12) Patent Application Publication
(10) Pub. No.: US 2006/0086049 A1
(43) Pub. Date: Apr. 27, 2006

(54) Door module for vehicle door

(75) Inventors: Michael von Mayenburg, Lake Oswego, OR (US); Nasser Zamani, West Linn, OR (US)

Correspondence Address: KLARQUIST SPARKMAN, LLP, 121 SW SALMON STREET, SUITE 1600, PORTLAND, OR, 97204, US

(73) Assignee: Freightliner LLC

(21) Appl. No.: 11/254,328

(22) Filed: Oct. 19, 2005

Related U.S. Application Data
(60) Provisional application No. 60/622,269, filed on Oct. 25, 2004.

(51) Int. Cl. E05F 15/16

(52) U.S. Cl. 49/349; 49/502

(57) ABSTRACT

Embodiments of a door module a vehicle door are described herein. In one exemplary embodiment, a door module for mounting to a vehicle door with a lower edge portion and a window opening with a base edge comprises a structural modular carrier panel of a monolithic one-piece construction. The carrier panel is sized such that when mounted to the vehicle door the panel extends substantially from the base edge of the window opening to a location on the door spaced from the lower edge portion of the door. The door module includes a window and window lifter that comprises at least two elongate window guide channels configured to guide a window panel and mounted to the structural modular panel such that lower ends of the elongate window guide channels extend substantially beyond the lower end of the carrier panel. The door module can also include an opening and closing mechanism that is mounted to the modular panel and comprises an interior handle, an exterior handle and a latch mechanism.

### CROSS-REFERENCE TO RELATED APPLICATIONS

This application claims priority from U.S. Provisional Patent Application No. 60/622,269, filed Oct. 25, 2004, and that is incorporated herein by reference.

### FIELD

This invention relates to a door for a vehicle, and in particular, a modular door module for the door of a truck.

### BACKGROUND

Improvements in vehicle door constructions are desirable, particularly improvements which reduce the number of door components and which permit modular assembly of door elements so that in a vehicle assembly line, pre-assembled modular components may be used to thereby reduce the amount of time required for a vehicle to be assembled on the assembly line.

### SUMMARY

The present invention is directed toward all new and non-obvious features and method acts disclosed herein both alone and in novel and non-obvious combinations and subcombinations with one another. The invention is not limited to constructions which exhibit all of the advantages or components disclosed herein. The embodiments set forth herein provide examples of desirable constructions and are not to be construed as limiting the breadth of the disclosure.

The foregoing and other features and advantages of the invention will become more apparent from the following detailed description, which proceeds with reference to the accompanying figures.

### BRIEF DESCRIPTION OF THE DRAWINGS

FIG. 1 is a side elevational view of the exterior of one form of a door for a vehicle such as a truck.

FIG. 2 is a side elevational view of the interior of the door of FIG. 1 in a partially assembled condition with an exemplary carrier module mounted to the interior of the door.

FIG. 3 illustrates the door of FIG. 2 with a soft trim piece, in this case containing a lower pocket, mounted to the interior of the door and overlaying a portion of the carrier module depicted in FIG. 2. A portion of the carrier module is exposed to the interior of the vehicle of the finished door.

FIG. 4 illustrates a carrier module with various components shown in combination with a carrier panel of the module and looking from the interior of the cab of a vehicle toward the module.

FIG. 5 is a side elevational view much like the view in FIG. 4 except looking from the opposite direction toward the back side of the carrier module, the back side being the side of the carrier panel of the module that is positioned adjacent to the interior surface of the exterior door panel when the carrier module is assembled to the door panel.

FIG. 6 is an exploded view of the carrier module of FIGS. 4 and 5.

FIG. 7 is a view of a portion of the carrier module of FIG. 5 illustrating exemplary brackets for supporting a window guide channel located near the rear edge portion of the door and adjacent to a door latch.

FIG. 8 is a view of a portion of the carrier module of FIG. 5 showing a window guide supported by standoff brackets at an intermediate location of the module for a door of the type having a forward window vent and a divider that separates a main window panel from a window vent panel, it being understood that other windows (e.g., fill width) and door channels may be used in alternative constructions.

### DETAILED DESCRIPTION

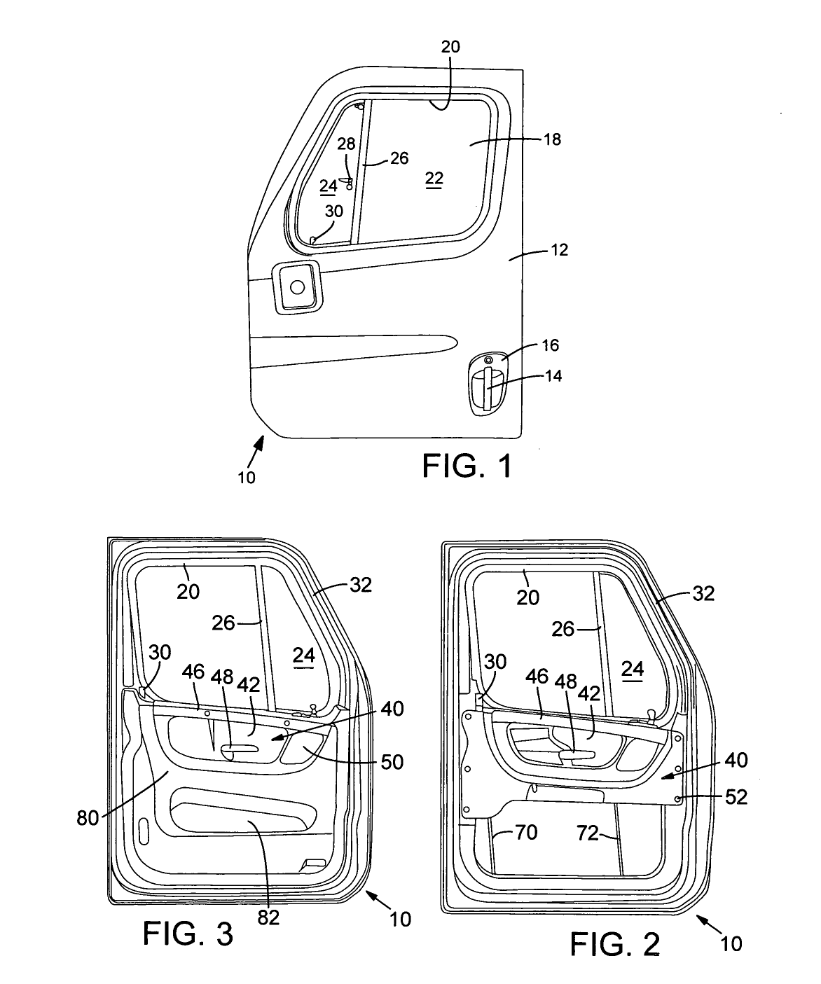

FIG. 1 illustrates an exemplary door 10 for a vehicle and more specifically depicts the exterior surface of an exterior panel 12 of the door 10. The illustrated door has an exterior latch releasing handle 14 carried by a bezel 16 that mounts within an opening provided in the exterior door panel 12. A window opening 18 is provided in the door 10 and is surrounded by a window seal 20 of rubber or other suitable material. The illustrated window opening has a main window section 22 and a vent window section 24 separated by an upright divider 26. A pivotable handle 28 is schematically shown for locking and operating the vent window. A door lock button 30, interiorly of the vent window 24, is provided for selectively locking the door. That is, in a conventional manner, button 30 is depressed to lock the door and extended when the door is unlocked. The button 30 may be actuated by a user or in response to a signal from a remote key in a conventional manner.

FIG. 2 illustrates the door 10 of FIG. 1 looking from the interior of the cab of a vehicle and prior to assembly of a fabric or trim panel. The illustrated door 10 comprises a peripheral seal 32 along with other components.

In accordance with the present disclosure, a carrier panel 40 is shown mounted to the interior of the door. The carrier panel 40 comprises a central portion 42 that is exposed to the interior of the door cab when the door is complete. This central portion thus comprises a portion of a trim panel portion of the carrier 40. The carrier 40 is a structural component that provides support for an interior grab handle 46 mounted thereto and that may be grabbed by someone egressing out of or ingressing into the cab or for use in shutting the door. Relatively high loads may be applied to the grab handle, such as 300-400 pounds. The carrier panel is structural in that it is designed to withstand such loads. In addition, carrier panel 40 supports an interior door handle 48 which is moved to operate the door latch to unlatch the door as desired. An optional speaker grill 50 desirably overlies a speaker support area of the carrier panel 40. A speaker, if included, is supported by carrier panel 40 and between the interior surface of the door panel 12 and the interior surface (interior being inside the door) of the carrier panel 40. A plurality of fasteners (e.g., three at each side of carrier panel 40), with one being indicated at 52, are provided for securely mounting the carrier panel to the door.

The carrier panel is desirably made of a tough durable material, such as polypropylene with reinforcing fibers therein, such as containing twenty percent fiberglass fibers. Another example is polycarbonate ABS which can be chromed as desired. This latter material may, for example, also be used for the bezel 16 and handle 14 (and also for handle 48) with the handles typically being made of two components which may be snapfit together or otherwise interconnected to create a hollow handle. Other materials may also be used.

As can be seen in FIG. 2, an aft window glass guiding channel 70 is provided and is desirably mounted to the carrier panel 40. In addition, a forward glass guiding channel 72 is also provided and is also desirably carried by the carrier panel 40. Guide channels 70 and 72 guide the motion of the main window 22 as it is raised and lowered. When closed, the forward edge of the window 22 bears against a divider 26 with the window being sealed by seal 20. In a conventional manner, forward guide 72 is aligned with divider 26 to guide the window into the divider 26 as the window is raised.

FIG. 3 illustrates the door 10 with a soft trim panel 80 in place. As is apparent from FIG. 3, portions of the carrier panel 40 are desirably exposed to the interior of the cab after the trim panel is installed. The illustrated form of trim panel includes a lower compartment or pocket defining portion 82 below the exposed portion of the carrier panel 40.

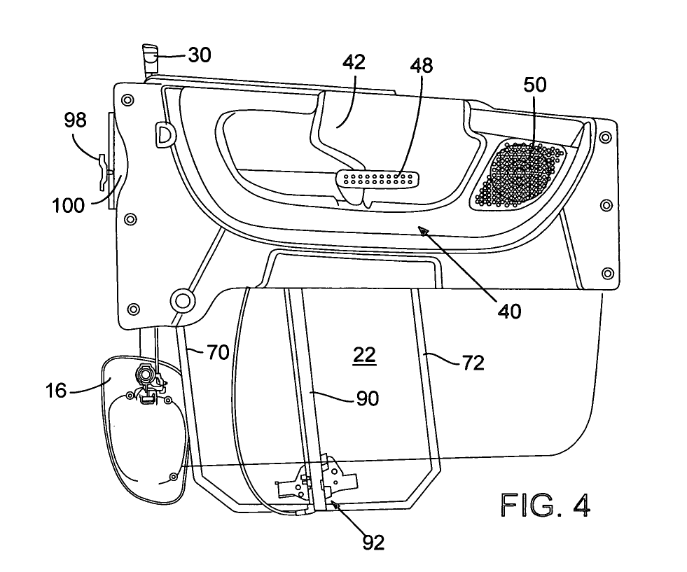

With reference to FIG. 4, a conventional window lift regulator 90 and actuator 92 are shown. When actuated, power (e.g., electric power) is provided to a motor to cause the window to be moved in the appropriate direction. It should be noted that window 22 may be wider than shown in FIG. 4. Also, the forward glass run channel 72 has been shifted slightly in this figure for convenience. A vapor barrier may also be provided between the interior surface of the exterior door panel 12 and the interior surface of the carrier 40. The vapor barrier also desirably covers the portion of the door panel overlaid by the soft trim 80 in FIG. 3. The interior surface of the bezel 16 that carries the outside release handle is also shown in FIG. 4 together with a release rod 96 coupled to a latch actuator for a latch 98 for operating the latch to open the door when the release handle is operated. A latch bracket 100 carried by the panel 40 supports the latch 98 and latch bracket 100.

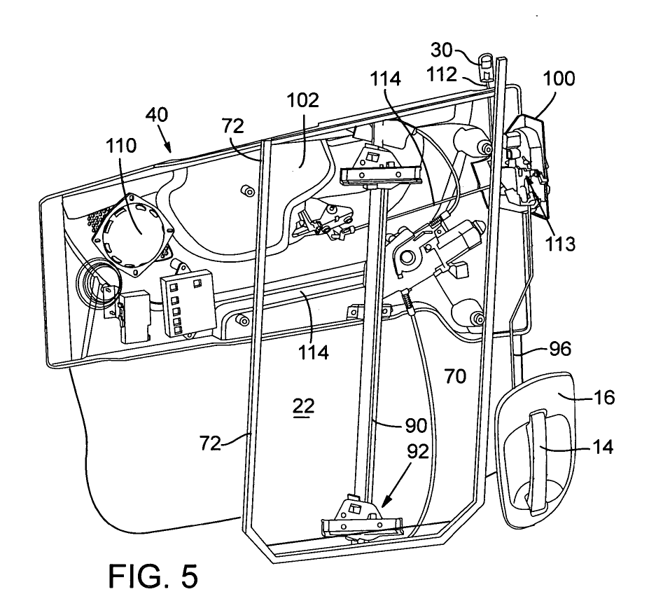

With reference to FIG. 5, the interior surface 102 of panel 40 is shown. In this figure, a speaker 110 is shown mounted to the interior surface 102 in the region of the speaker grill 50. In addition, a latch actuating rod 112 is shown extending from button 30 to the latch actuating mechanism 113. Also, a latch rod 114 is shown extending from the interior surface of panel 102 adjacent the handle 48 (on the opposite side of the panel from that shown in FIG. 5) to mechanism 113 for actuating the latch to open the door when the interior door handle is moved. A conventional coupling mechanism may be used to couple rod 114 to the handle. Additional window raising and lowering components are also shown mounted to the interior surface of 102 of panel 40. The reference to the door electronic module package protect simply means that this space may be reserved for supporting additional electronics that may be included in the door. A side airbag may also be mounted to panel 102, for example to the central portion of this panel, with a suitable air bag deployment opening being provided through the panel with an overlying cover. A support bar 114 mounted to the interior surface 102 of the panel is provided for supporting various components such as portions of the window actuating mechanism. Guide bar 72 is also shifted in this figure slightly for convenience in illustrating the construction.

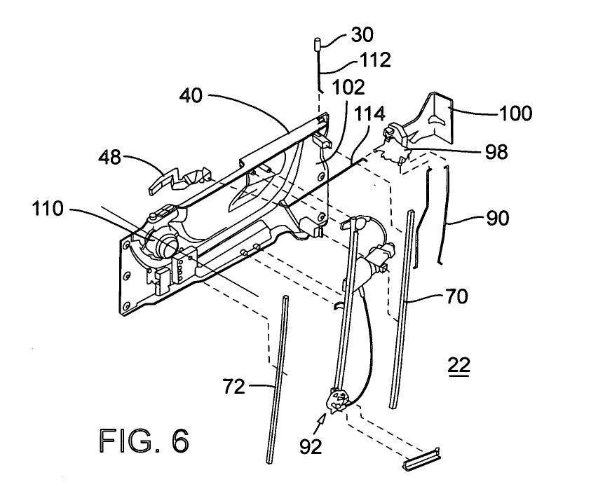

FIG. 6 illustrates an exploded view of the door carrier panel and exemplary components that may be mounted thereto to form the carrier module.

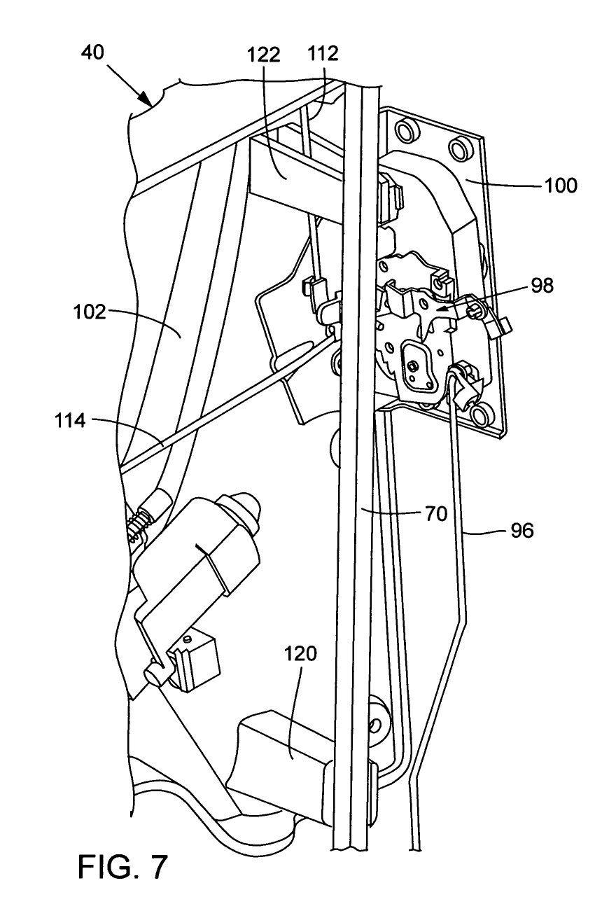

FIG. 7 illustrates a portion of the carrier panel 40 illustrating exemplary standoff brackets 120,122 which may be mounted to the door panel, or desirably are formed integral with the door panel, for supporting glass guiding channel 70.

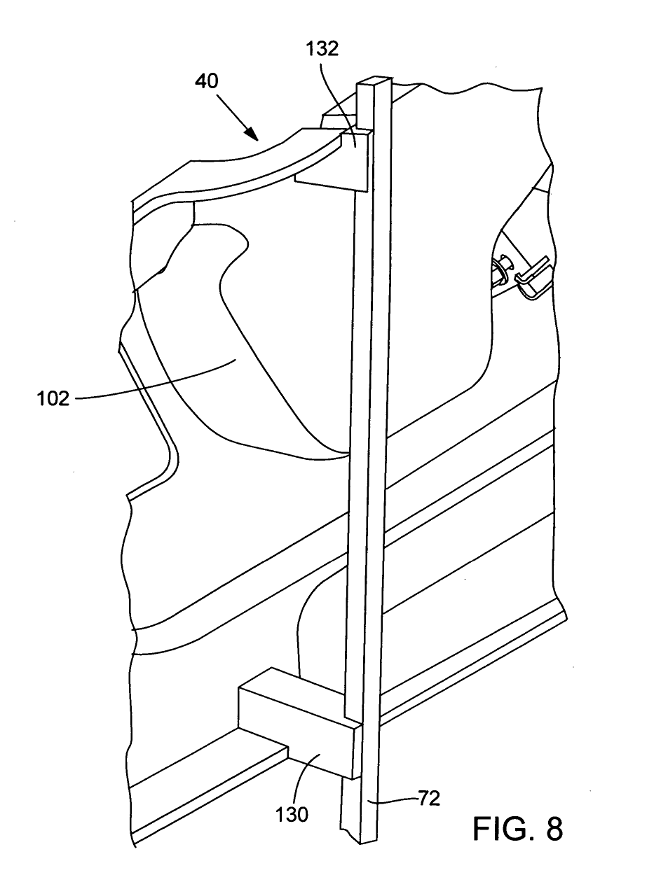

FIG. 8 illustrates a portion of the door panel with standoff brackets 130,132 which may be mounted to the interior surface 102 of the door panel for supporting glass guiding channel 72. Brackets 130,132 are more desirably formed integral with the door panel.

A modular door panel construction with one or more and more desirably plural components mounted thereto, such as illustrated herein, may be assembled in advance and provided as an assembled modular unit to a vehicle assembly line. As a result, the time required to install door components at the assembly line is reduced. The present invention is directed toward all novel and non-obvious method acts and features disclosed herein both alone and in various combinations and subcombinations with one another. The invention does not require all components or all advantages to be solved in particular embodiments.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A door assembly for use with a vehicle, comprising:
a door exterior comprising an exterior door body and defining a window opening having a window base along a lower portion of the window opening, the door body defining an interior cavity opening having an upper section and a lower section; and
a carrier panel comprising a monolithic carrier body coupled to the door body, the carrier body comprising upper and lower edge portion and first and second spaced apart side edge portions, the carrier panel extending from a portion of the door frame proximate the window opening base to a portion of the door frame away from the door frame base portion, wherein the carrier panel substantially covers the upper section of the interior cavity opening without the carrier body covering the lower section of the interior cavity;
a window and window lifter, the widow lifter comprising least two elongate window guide channels in guiding communication with the window and mounted to the carrier panel, wherein upper ends of the window guide channels are positioned adjacent the window opening base and lower end of the window guide channels are positioned in the lower section of the door cavity and projecting below the carrier panel; and
a trim panel mounted to the door frame and the carrier panel without a hinge such that a portion of the trim panel overlaps a portion of the carrier panel, wherein a portion of the trim panel also substantially covers the lower section of the interior cavity opening of the door frame.

2. The door assembly of claim 1, wherein the carrier panel covers between approximately one-third and approximately two-thirds of the interior cavity opening.

3. The door assembly of claim 1, wherein the carrier panel comprises a central portion exposed to an interior of the vehicle when the carrier panel is mounted to the door frame and the trim panel is mounted.

4. The door assembly of claim 1, wherein the carrier panel comprises an interior grab bar proximate the window base, the interior grab bar being positioned for access by a person egressing out of or ingressing into the vehicle.

5. The door assembly of claim 4, wherein the interior grab bar is capable of supporting loads of 300 lbs or more.

6. The door assembly of claim 1, wherein the trim panel comprises an interior pocket configured to store objects, the pocket being positioned below the carrier panel when the carrier panel and trim panel are coupled to the door frame.

7. The door assembly of claim 1, wherein the window lifter comprises a window lift regulator coupled to the window and configured to selectively raise and lower the window.

8. The door assembly of claim 1, further comprising an interior release handle and an exterior release handle coupled to a latch mechanism, wherein the interior release handle, exterior release handle and latch mechanism are mounted to the carrier panel.

9. The door assembly of claim 1, further comprising a speaker device mounted to the carrier panel.

10. The door assembly of claim 1, wherein the carrier panel comprises integrated mounting brackets, and wherein the window guide channels are mounted to the integrated mounting brackets.

11. A door module assembly assembled prior to mounting to a vehicle door, the vehicle door having a lower edge portion and a window opening with a base edge, comprising:
a structural modular carrier panel of a monolithic one-piece construction, the carrier panel when mounted to the vehicle door being sized to extend substantially from the base edge of the window opening to a location on the door spaced from the lower edge portion of the door;
a window and window lifter comprising at least two elongate window guide channels configured to guide a window panel and mounted to the structural modular panel such that lower ends of the elongate window guide channels extend substantially beyond the lower end of the carrier panel; and
an opening and closing mechanism mounted to the modular panel and comprising an interior handle, an exterior handle and a latch mechanism.

12. The door module of claim 11, wherein an interior portion of the vehicle door between the base edge of the window opening and the lower edge of the door defines an inner vehicle door surface, and wherein the modular carrier panel when mounted to the vehicle door being sized to vertically overlay between approximately one-third and approximately two-thirds of the inner vehicle door panel surface when mounted to the door.

13. The door module of claim 11, wherein the modular panel comprises an interior grab bar proximate the base edge of the window, wherein the interior grab bar is positioned for access by a person egressing out of or ingressing into a vehicle when the modular carrier panel is mounted to a vehicle door.

14. The door module of claim 13, wherein the modular panel comprises inwardly extending integrated mounts, and wherein the window guide channels are mounted to the integrated mounts.

15. A method of assembling a door module for a vehicle door prior to mounting the door module to the door, comprising:
providing a modular carrier panel that when mounted to the vehicle door is sized to extend substantially from a lower edge of a window opening of the door to a portion of the door spaced from a base edge of the door; and
mounting a window, a window lifter, an interior handle, an exterior handle and a latch mechanism to the modular carrier panel, wherein the window panel comprises at least two elongate window guide channels in guiding communication with the window, and wherein the at least two elongate window guide channels each extend below the carrier panel.

16. The method of claim 15, further comprising mounting a soft trim piece to the carrier panel such that when mounted to the door the soft trim piece extends substantially from the base edge of the door the carrier panel.

17. A door module for mounting to a vehicle door, the vehicle door comprising first and second door side edges, a window opening with a lower base and a lower door edge portion, the door module comprising:
a monolithic one-piece carrier panel;
the carrier panel comprising an upper edge portion, and first and second spaced apart grab bar supporting shelves each being positioned adjacent to and below the upper edge portion of the carrier panel; and
an elongated grab bar comprising a first end portion supported by the first supporting shelf and a second end portion supported by the second supporting shelf.

18. The door module of claim 17, wherein the carrier panel is sized in the vertical direction to span an area of the door extending substantially from the lower base of the window opening to a lower central section of the door between the lower base of the window opening and the lower door edge portion.
